(19) United States
(12) Patent Application Publication
(10) Pub. No.: US 2009/0150442 A1
(43) Pub. Date: Jun. 11, 2009

(54) AGGREGATION OF PERSONS-OF-INTEREST INFORMATION FOR USE IN AN IDENTIFICATION SYSTEM

(76) Inventors: Ryan Barnard, Port Townsend, WA (US); Nelson Ludlow, Port Townsend, WA (US)

Correspondence Address: PERKINS COIE LLP;PATENT-SEA, P.O. BOX 1247, SEATTLE, WA, 98111-1247, US

(21) Appl. No.: 12/197,188

(22) Filed: Aug. 22, 2008

Related U.S. Application Data
(60) Provisional application No. 60/957,439, filed on Aug. 22, 2007.

(51) Int. Cl. G06F 17/30; G06F 3/048

(52) U.S. Cl. 707/104.1; 715/810; 707/E17.044

(57) ABSTRACT

A facility for aggregating information about persons-of-interest for use in an identification system. Person-of-interest information may include, for example, crimes or/and activities for which a person has been suspected, charged, or convicted. Person-of-interest information may include descriptive characteristics of a person, such as a person's name, alias, height, weight, date of birth (“DOB”), or other information that may be used to identify a person. The facility identifies one or more data sources from which to retrieve person-of-interest information. For each person of interest, the facility parses from the retrieved information a plurality of attributes characterizing the person of interest, and stores the parsed information in a record associated with the person of interest. Based on the attributes characterizing the person of interest, the facility may determine a relative level of danger posed by the person.

### CROSS-REFERENCE TO RELATED APPLICATION

This application claims the benefit of U.S. Provisional Application No. 60/957,439 entitled “AGGREGATION OF PERSONS-OF-INTEREST INFORMATION FOR USE IN AN IDENTIFICATION SYSTEM,” filed Aug. 22, 2007.

### BACKGROUND

Public and private law enforcement officers, security guards, and other security personnel are expected to utilize all information available to them when performing their jobs. For example, security personnel should presumably have some knowledge about the “most wanted” list published by the FBI. Unfortunately, security personnel are often unable to effectively utilize many public data sources about criminals or other suspects because there is no centralized access to the data sources. Without centralized access, security personnel cannot easily extract actionable information in a timely fashion. The access problem is exacerbated by the growing base of information that becomes available every day. Without tools to access such information, security personnel are forced to work with only a fraction of the available information that may be helpful in their job. In light of the recent security threats in the world, it is critical that security personnel have access to a broad variety of data sources and the ability to use them in a timely manner. A system that allowed access to such information would be a significant benefit to the safety and security of public and private facilities.

### BRIEF DESCRIPTION OF THE DRAWINGS

FIG. 1A is a block diagram of a software and/or hardware facility that aggregates persons-of-interest information for use in an identification system.

FIG. 1B is a block diagram of a representative architecture of an aggregator service.

FIG. 2 is a flow chart of a process for aggregating persons-of-interest information.

FIG. 3 is a representation of a user interface that enables a user to select one or more data sources for aggregating persons-of-interest information.

FIGS. 4A and 4B show an example “wanted poster” and a portion of the corresponding HTML code for generating the wanted poster.

FIG. 5 is a representative record depicting POI information associated with a person of interest.

### DETAILED DESCRIPTION

A hardware and/or software facility for aggregating information about persons-of-interest for use in an identification system is disclosed. Person-of-interest information may include, for example, crimes or/and activities for which a person has been suspected, charged, or convicted. Person-of-interest information may also include descriptive characteristics of a person, such as a person's name, alias, height, weight, date of birth (“DOB”), or other information that may be used to identify a person. The facility identifies one or more data sources from which to retrieve person-of-interest information. For each detected person of interest, the facility parses from the retrieved information a plurality of attributes characterizing the person of interest, and stores the parsed information in a record associated with the person of interest.

In some embodiments, the facility may analyze the attributes characterizing the person of interest in order to determine a characterization of the person of interest. For example, the facility may determine a relative level of danger posed by the person. The characterization of the person of interest may be stored in the record associated with the person of interest.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

Content Aggregation Facility

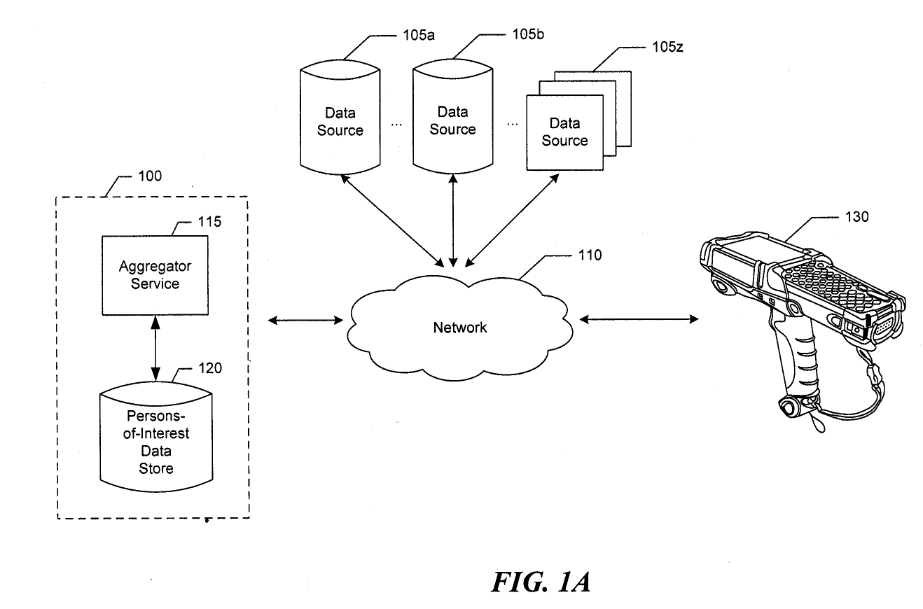

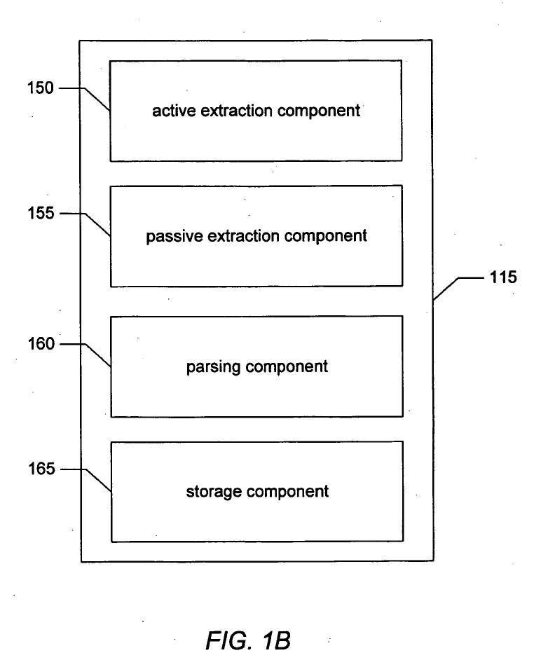

FIG. 1A illustrates a software and/or hardware facility (“the facility”) 100 that aggregates information about persons-of-interest (“POI information”) for use in an identification system. POI information may include a variety of information about one or more individuals. For example, POI information may include a list of crimes or/and activities for which a person has been suspected, charged, or convicted. POI information may include descriptive characteristics of a person, such as a person's name, alias, height, weight, date of birth (“DOB”), Social Security Number (SSN), Drivers License or ID number, Case Number, or other information that may be used to identify a person. POI information may also include permissions associated with a person or persons, such as an authorization to enter a controlled facility.

The facility gathers POI information from one or more data sources 105a, 105b . . . 105z. Data sources may be public or proprietary, governmental or non-governmental. For example, data sources 105a, 105b . . . 105z may include databases maintained by the FBI, Immigration and Customs Enforcement, U.S. Secret Service, Drug Enforcement Agencies, Interpol, U.S. Postal Service, State Law Enforcement Agencies, U.S. Air Force, U.S. Coast Guard, U.S. Marshals, Navy/Marine Corps, Attorney General's Office, Department of Corrections, Department of Public Safety, state or national sex offender registry, county law enforcement agency, sheriffs office Most Wanted, city law enforcement agency, National Crime Information Center (NCIC), state or federal active warrants, Crime Stoppers, America's Most Wanted, Bail Jumpers, or other public or private sources of data such as a corporate employee database, airline databases, etc. Data sources 105a, 105b . . . 105z may be accessed through a public or private network 110, such as the Internet or local area network, and data may be retrieved via web service calls, database queries, web site scraping, data queries, or other access techniques known to those skilled in the art. For example, facility 100 may include a web crawler that browses a network in a methodical, automated manner looking for data sources 105a, 105b . . . 105z containing POI information. Data may be gathered by the facility from the one or more data sources 105a, 105b . . . 105z, or the data may be pushed to the facility on a continuous or periodic basis. For example, copies of data sources or updates to data sources may be periodically delivered by a data source owner to the operator of the facility. As another example, the operator of facility 100 may select one or more data sources 105a, 105b, . . . 105z from which data is pulled.

The facility includes an aggregator service 115 that collects POI information and converts the POI information, if necessary, into a format that is utilized by the facility. In some embodiments, the aggregator service reconciles the parsed data with previously-stored data to ensure that duplicate entries do not exist for identical or similar individuals. The aggregator service 115 may also determine whether the received data contains new or changed POI information. The aggregator service 115 may only update the previously-stored information if the POI information is new or changed.

The facility also includes a persons-of-interest data store 120 that is used by the facility to store a record associated with each person of interest. For example, a person's record may include descriptive characteristics of the person, such as the person's name, alias, height, weight, date of birth (“DOB”), scars, tattoos, or other information that may be used for identification. A record may include a list of crimes or/and activities for which the person has been suspected, charged, or convicted. A record may also include an indication of the level of danger associated with the person. For example, when a person has an outstanding arrest warrant for felony embezzlement, the record may include an indication that the person is a Non-Violent BOLO (“Be On the Look Out for”). As another example, a record may include permissions associated with the person, such as a person's rank, service, classification level, organization, etc. As yet another example, a record may include asset information, such as property (e.g., address) or vehicle information (e.g., make, model, year, VIN, etc.). POI information may be automatically or manually entered into data store 120. For example, a user of the facility may update a record or create a new record in data store 120.

Those skilled in the art will appreciate that the format for storing information about a person of interest may vary widely between data sources. Although the previous description contemplated a single record associated with an individual, it will be appreciated that one or more records may be associated with each individual. For example, data store 120 may include two records for a person who is wanted by the Seattle FBI and by Immigrations and Customs Enforcement. In such cases, a superior record may provide a link or other mapping to associate the two records with the person of interest. The ability to recognize variant formats of information is useful for a number of reasons. For example, without this ability, it is difficult to automatically group multiple records of a single person (e.g., provide the context of all the crimes and/or activities for which the person has been suspected, charged, or convicted). Similarly, without this information, it is difficult to automatically generate behavioral statistics or other relative valuations (e.g., estimate the relative danger that a person may pose to officials when that person is apprehended).

In some embodiments, the facility provides POI information that is stored in data store 120 to a scanning device 130. Scanning device 130 includes one or more scanning components. For example, scanning device 130 may include a digital scanner, a magnetic reader, a one dimensional bar code scanner, a two-dimensional bar code scanner, an RFID reader, or other scanning or information gathering component. An operator of scanning device 130 may scan one or more pieces of identification (IDs) having machine-readable information. For example, scanning device 130 may scan driver licenses, military or government IDs, passports, RFID chips, corporate IDs, or other form of ID comprising machine-readable information.

One or more records stored in data store 120 may be copied or made available for access by a scanning device 130. For example, scanning device 130 may include a database comprising an exact copy of each record of data store 120. As another example, the scanning device may be able to access the database remotely through a public or private network 110. When an ID is scanned by an operator of the scanning device 130, the scanning device determines if the ID includes information matching one or more of the records associated with person-of-interests. In some embodiments, all of the scanned information must match the information in a record of a person of interest. In some embodiments, only a portion of the scanned information must match the information in a record of a person of interest. One or more of the matching records may be displayed to the operator on the scanning device. For example, the operator may have a record displayed that indicates that the holder of the scanned ID is a suspected terrorist. As another example, the operator may have a message displayed that indicates that the individual is not authorized to enter a secure facility. Co-pending U.S. patent application Ser. No. 11/843,621, filed on Aug. 22, 2007 and entitled, “DYNAMIC IDENTITY MATCHING IN RESPONSE TO THREAT LEVELS,” which is herein incorporated by reference, describes an identification system in which the POI information aggregated by the facility may be utilized.

Those skilled in the art will appreciate that various architectural changes to the facility may be made while still providing similar or identical functionality. For example, the functionality of the facility may be built into or combined with the functionality of scanning device 130.

FIG. 1B depicts a representative architecture of the aggregator service 115. As shown, the aggregator service 115 comprises several software components, including an active extraction component 150, a passive extraction component 155, a parsing component 160, and a storage component 165. The active extraction component 150 selectively extracts POI information from data sources 105. For example, the active extraction component may include one or more web crawlers that locate and extract POI information. The passive extraction component 155 extracts POI information from data that is pushed to or received by the facility, for example, on a continuous, periodic, or sporadic basis. The parsing component 160 parses the extracted POI information to identify attributes of one or more persons of interest, such as, for example, the person's name, age, crimes for which the person is suspected, a phone number of the reporting authority, etc. As another example, the parsing component 160 may parse POI information to determine a relative meaning of the information, such as, for example, the danger that a person may pose to officials when that person is apprehended. The storage component 165 imposes structure on the data that is stored in the persons-of-interest data store 120.

The aggregator service 115 may be implemented on any computer or computing system, whether monolithic or distributed. Suitable computing systems or devices including personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. Such computer or computing system may include one or more processors that execute software to perform desired functions. Processors may include programmable general-purpose or special-purpose microprocessors, programmable controllers, application specific integrated circuits (ASICs), programmable logic devices (PLDs), or the like, or a combination of such devices. The software may be stored in memory, such as random access memory (RAM), read-only memory (ROM), flash memory, or the like, or a combination of such devices. Software may also be stored in one or more storage devices, including any conventional medium for storing large volumes of data in a non-volatile manner, such as magnetic or optical based disks, flash memory devices, or any other type of non-volatile storage device suitable for storing data.

Acquiring Aggregated Content on a Mobile Device

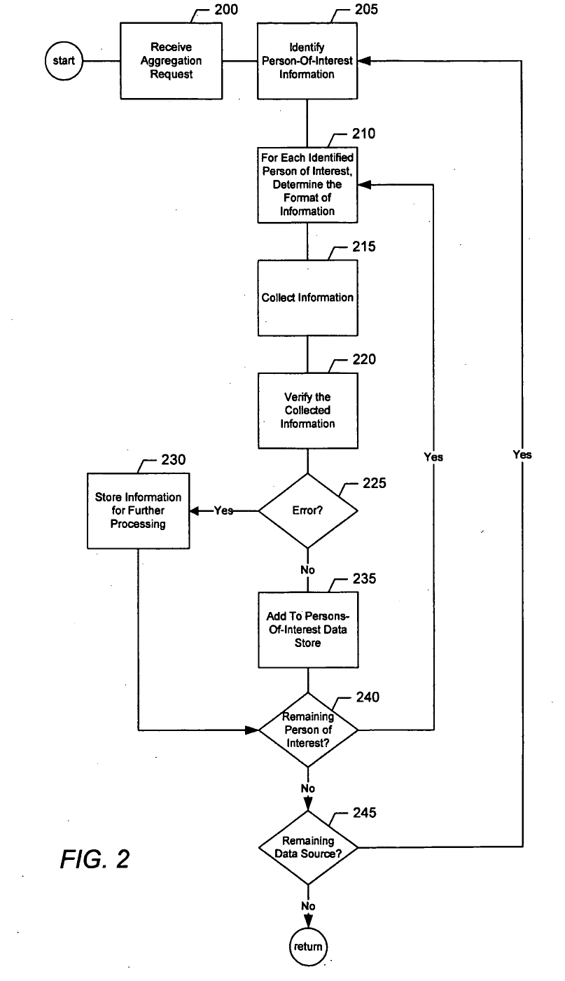

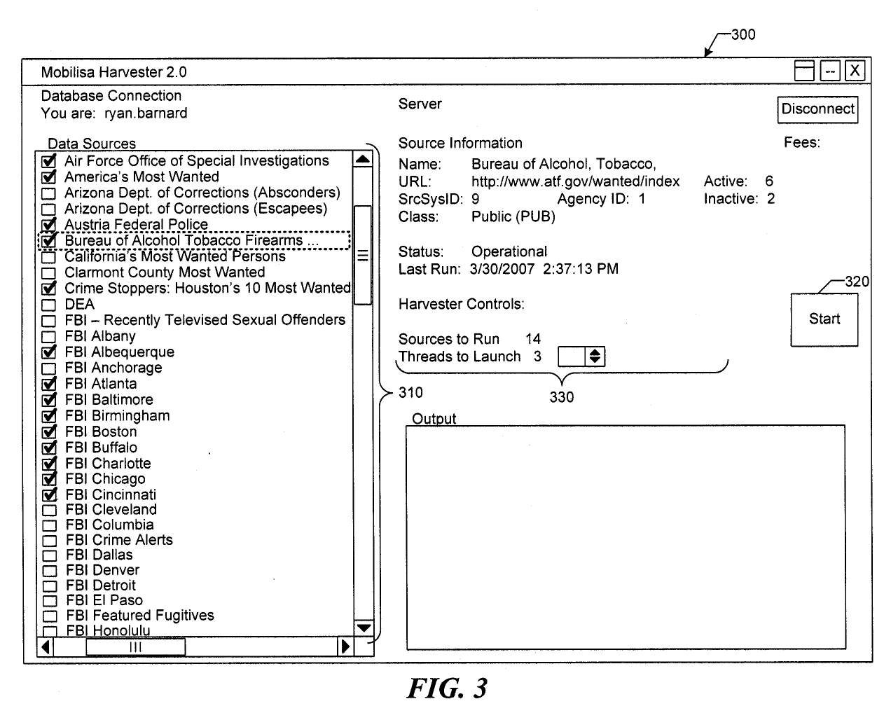

FIG. 2 is a flow chart of a representative process performed by the facility to aggregate POI information. In step 200, the facility receives a request to aggregate POI information from one or more data sources 105a, 105b, . . . 105z. The request may be an automatic request or computer process, such as an aggregation process that is automatically implemented on a daily or weekly basis. Alternatively, the request may be a manual request. For example, FIG. 3 is a representation of a user interface 300 that enables an operator to manually select one or more data sources 105a, 105b, . . . 105z. The data sources are represented in a list 310 that has a check box associated with each data source. An operator may select one or more data sources to be scanned by checking the box next to each data source. After selections have been made, a start button 320 is selected to initiate the aggregation process. Information about each data source may be presented to the operator in a source information region 330.

At step 205, the facility identifies POI information from the one or more data sources 105a, 105b, . . . 105z. For example, when the Seattle FBI (http://seattle.fbi.gov) is selected as a data source, the facility may use a web crawler to browse its network to find information associated with one or more persons of interest.

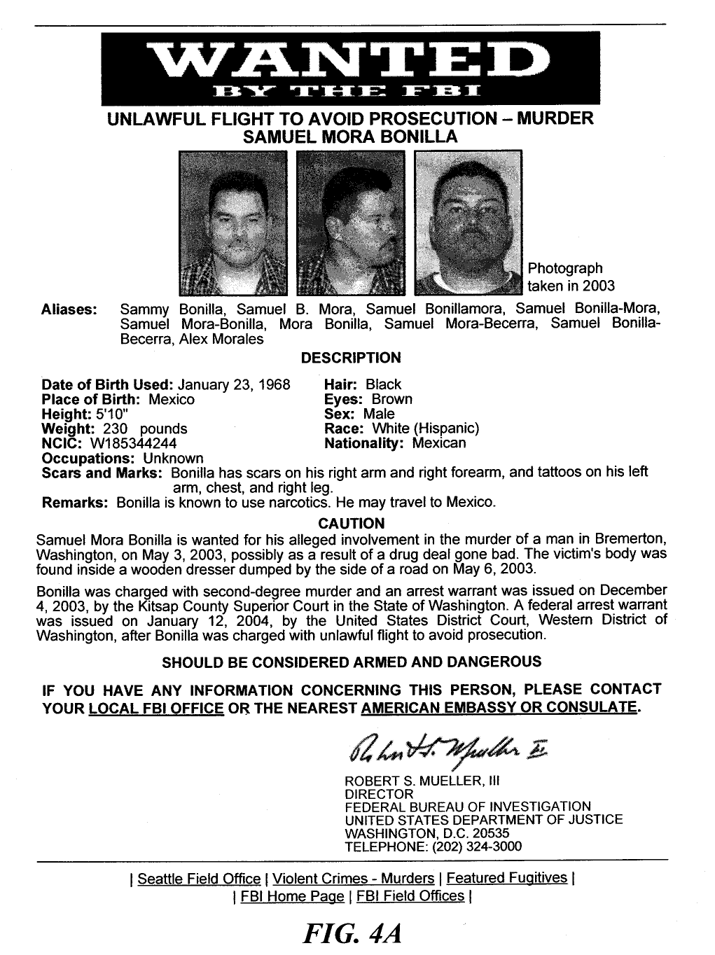

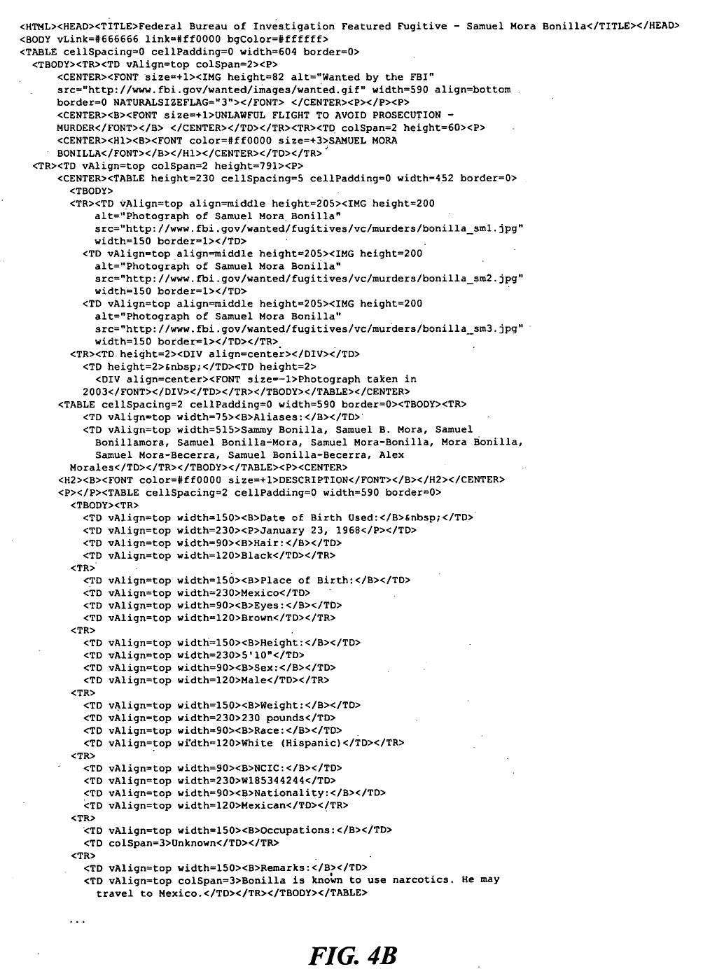

For each person of interest that is identified, at step 210 the facility determines the format of the data associated with that person of interest. In some embodiments, the facility may analyze the structural semantics and/or syntax and determine that the data is presented in a format known to the facility. For example, “wanted posters” are in a format known to the facility. The wanted person's name is usually first and in capital letters, and may be followed by a string of aliases. An example “wanted poster” is shown in FIG. 4A. In some embodiments, the facility may parse the data and identify key words or tags that are indicative of different types of data. For example, the facility may identify words such as “height,” “weight,” etc. As another example, the facility may implement an SGML parser to identify tags within the document that indicate the presence of POI information to be collected. FIG. 4B shows a portion of the HTML code used to generate the wanted poster shown in FIG. 4A. In some embodiments, the facility utilizes a local or remote service to parse identified documents. The service description of the service includes XML elements specifying the POI information to return from a parsed document. These elements may contain, for example, regular expressions to extract specific pieces of POI Information, such as Name, Date of Birth, Height, Weight, Hair Color, Eye Color, Gender, Race, Nationality, Aliases, Crimes, etc. The data analyzed by the facility may be contained in a tagged document, a table, a text document, a CSV file, or any other format used by data sources 105a, 105b, . . . 105z.

Those skilled in the art will appreciate that the facility may utilize one or more templates that specify the format of the data on a per-data-item or per-data-source basis. For example, the format of the data may include attribute types, values and/or arrangements of characters, numbers, punctuation, etc. A template provides a set of rules that allows data from data sources to be parsed and converted, if necessary, into data that may be manipulated by the facility. In some embodiments, the facility generates a new template or selects an existing template each time the facility aggregates POI information from an item or data source. In some embodiments, the facility stores an indication of a generated or selected template associated with an item and/or data source, such that the template need not be generated each time that the item or data source is accessed. In some embodiments, the facility may measure the number of errors (such as, for example, when an integer is mapped to an attribute having a string format) that occur when a template is being used to parse a data item or source. If the number of errors exceeds a threshold (indicating, for example, a change in the formatting of the data item or data source), the facility may generate a new template or modify the existing template for that data item or data source.

At step 215, the facility collects information from the item about the person of interest. In some embodiments, the facility determines that all or a portion of the collected information is in an unknown format. In such embodiments, the facility may utilize one or more artificial intelligence (AI) techniques to parse the collected information (such as, e.g., machine learning, neural networks, fuzzy logic, production rules, natural language processing, etc.). For example, the facility may utilize the following process to determine the height of a person of interest:
Scan data (e.g., text) for the form: f′i″
   Where, f=={4,5,6,7}; i={0 . . . 11}
If found, convert the data to a height value and store in POI record.

As another example, the facility may utilize the following process to identify and process dates information:
Scan data for strings in the form “mm/dd/yyzz” or “mm/dd/zz” or enumeration of Day Type and in “Day dd, yyzz”
   Where mm=={1.12}, dd=={1.31}, yy=={19,20}, zz=={00.99}
   Where Day=={Sunday, Monday, Tuesday, Wednesday, Thursday, Friday, Saturday, SUN, MON, TUE, WED, THU, FRI, SAT}
   Look for all forms of month spellings (January, Jan, etc.)
   Finite Enumeration Type
If found, assign type Date
   For each Date found, determine the date classification (e.g., date of birth (DOB), warrant issue date, etc.)
   For each Date classified, error check the date (e.g., warrant issue date is not prior to DOB, etc.)
   If a date classification cannot be determined, tag the Date as unknown and create an alert for an operator review.

As yet another example, the facility may utilize the following process to identify a color and associate the color with an attribute (eye, hair, car, etc.):
Scan data for all forms of spellings of color strings (e.g., “Brown”, “Bro”, “Brn”, “Black”, “Blk”, etc.)
   Finite Enumeration Type
For each identified Color, determine its attribute association (e.g., eye, hair, car, etc.):
   Pass identified color string into color enumeration to determine the most likely attribute candidate
      If color enumeration returns an exact match, associate the attribute to the enumerated color (e.g., eye color→Green) and store in POI record;
      If color enumeration returns an approximate match, or if attribute association cannot be determined, tag Color as unknown and create an alert for an operator review.

In some embodiments, collected POI information may be converted. For example, a person's height that is provided in centimeters may be converted to feet and inches, and weight provided in kilograms may be converted to pounds. As another example, descriptions of crimes committed by an individual may be mapped to a master crime vocabulary that is used by the facility. In this fashion, there is consistency in how certain crimes are displayed across jurisdictions.

At step 220, the facility verifies that the collected information is within an acceptable range. For example, when analyzing height, a person will not have a negative height or a height above a predetermined number (such as 8 feet tall). If the collected information falls outside of an expected range, an error flag may be set. In some embodiments, artificial intelligence (AI) techniques can be employed to detect and correct errors. For example, if the eye color attribute (having type string) is mapped to the age attribute (having type integer), the facility may identify and correct the invalid mapping.

At step 225, the facility determines whether an error resulted from any of steps 210, 215, or 220. For example, step 220 will result in an error if the facility collects information indicating that a person is two hundred years old. If the facility determines that an error occurred, the facility stores the collected information or a reference to the collected information for further processing at step 230. For example, the facility may store a link to the information to enable an operator to later manually inspect the data and determine the cause of the error condition. In some embodiments, the information itself is stored for further processing.

If the facility determines that no error occurred, the facility stores the collected information at step 235 into a record of data store 120. In some embodiments, the facility will compare the collected information with information already in the data store and only make a change to the stored information if the collected information is new. At step 240, the facility determines whether all the identified persons of interest from a data source have been processed. If any persons of interest remain, the facility executes steps 210-240 for each remaining person. If there are no remaining persons of interest, at step 245, the facility determines whether all identified data sources 105a, 105b, . . . 105z have been processed. If there are any remaining data sources, the facility executes steps 205-245 for each remaining data source.

In some embodiments, the facility identifies a record as inactive and/or removes the record from the data store 120 when, for example, the record is associated with a person who is captured, exonerated, becomes deceased, etc. For example, some data sources may include a “captured” list that identifies persons of interest who have been apprehended by the authorities. When the facility learns that a person of interest has been moved to the captured list, the facility may mark the corresponding record as inactive and/or remove the record. As another example, when a data source no longer includes information identifying a particular person as a person of interest, the facility may remove or mark the record or records associated with that person as inactive. In some embodiments, when a person of interest is removed from a data source, the facility allows a period of time to elapse before marking the corresponding record as inactive and/or removing the record. The elapsed period of time may be based on whether the data source is public or private, the reputation or stability of the data source, and/or the number of data sources indicating that the person is no longer of interest. For example, if a data source is stable, the record may be marked as inactive upon detection. If the data source is unstable, the facility may wait a week or more before marking the record as inactive (waiting for a certain period minimizes the chance that the omission of the person from the data source was a temporary error). As another example, the facility may identify governmental data sources as more trustworthy and/or stable than non-governmental sources. The omission of a person of interest from a governmental data source may therefore be acted upon more quickly than the omission of a person of interest from a non-governmental data source. As yet another example, POI information that is pushed to the facility may be considered more reliable than pulled POI information. It will be appreciated by those skilled in the art that the elapsed period of time may be based on a number or considerations and is not limited to the examples described.

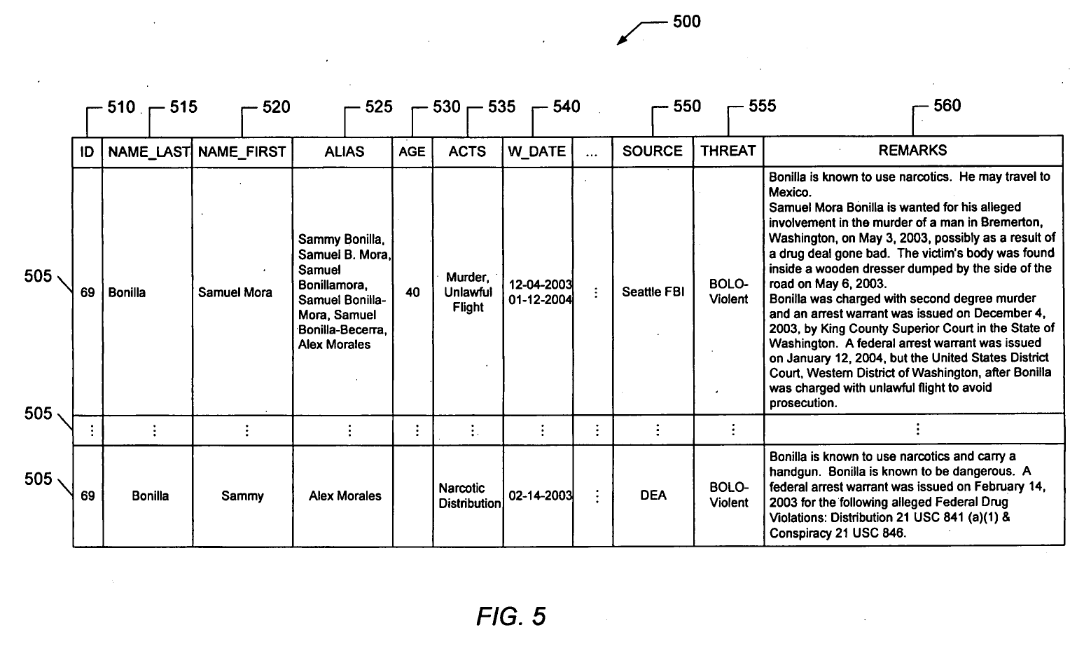

FIG. 5 depicts a representative record 500 containing POI information associated with a person of interest. Record 500 includes one or more entries 505, each entry representing aggregated POI information associated with a person of interest. Each entry 505 includes values for a number of attributes which characterize the person of interest. For example, an ID attribute 510 is used to store a unique identifier for each person of interest. One or more name attributes 515, 520, and 525 are used to identify the name and/or aliases of the person of interest. A date of birth and/or age attribute 525 is used to identify the age of the person of interest. An actions attribute 535 is used to identify acts or crimes for which the person has been suspected, charged, or convicted. A warrant date attribute 540 is used to identity if or when a warrant has been issued. A source attribute 550 is used to identify the data source from which the POI information was collected. A threat attribute 555 is used to store a perceived threat level that is generated by the facility for the person of interest. A remarks attribute 560 is used to store any other data, such as raw text, that the facility may learn about the person of interest. In some embodiments, the facility determines certain attribute values by analyzing the contents of the remarks attribute 560. It will be appreciated that one or more of the attributes depicted in record 500 may be omitted, or one or more attributes may be added, depending on the statistics and functionality that is to be provided by the facility.

It will be appreciated that rather than having each record 500 associated with a single person of interest, a table may be constructed wherein each entry identifies a file comprising the POI information associated with that person of interest entry. A single data table may then be used to reflect all persons of interest being aggregated. Moreover, while a single data table is depicted in FIG. 5, it will be appreciated that multiple data tables may be used to store portions of each record 500.

While FIG. 5 shows a table whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the disclosed functionality. Those skilled in the art will further appreciate that the steps shown in FIG. 2 may be altered in a variety of ways. For example, the order of the steps may be rearranged, substeps may be performed in parallel, steps may be omitted, or other steps may be included.

Furthermore, those skilled in the art will also appreciate that various portions of the facility may include one or more artificial intelligence components (e.g., neural networks, fuzzy logic, machine learning, production rules, natural language processing, etc.). Such components may be used to automate certain processes performed by the facility to make the facility more adaptive and/or efficient. For example, the aggregator service 115 may utilize a machine learning technique to facilitate the parsing of POI information having an unknown format.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A computer-readable storage medium comprising instructions for generating a user interface to aggregate person-of-interest information for use in an identification system, the instructions, when executed by a processor, cause the processor to:
display a plurality of electronic data sources to a user, each data source including person-of-interest information;
receive from the user a selection of the plurality of data sources; and
for each selected data source,
identify a template specifying one or more attributes that characterize a person of interest;
retrieve at least a portion of the person-of-interest information, the retrieved information being associated with a plurality of persons of interest; and
for each person of interest,
parse the retrieved information in accordance with the identified template; and
for each attribute characterizing the person, store the attribute in a record associated with that person, wherein the record is included in a data store accessible by the identification system to identify persons of interest.

2. The computer-readable storage medium of claim 1, wherein parsing includes identifying variant forms of attributes values.

3. The computer-readable storage medium of claim 1, wherein the plurality of electronic data sources are governmental data sources.

4. The computer-readable storage medium of claim 3, wherein the plurality of electronic data sources are selected by the user from the group consisting of a Federal Bureau of Investigation (FBI) database, an Immigration and Customs Enforcement database, a U.S. Secret Service database, a Drug Enforcement Agency database, an Interpol database, a U.S. Postal Service database, a State Law Enforcement Agency database, a military database, U.S. Marshals database, and an Attorney General's Office database.

5. The computer-readable storage medium of claim 1, wherein the plurality of electronic data sources are non-governmental data sources.

6. The computer-readable storage medium of claim 5, wherein the plurality of electronic data sources are selected by the user from the group consisting of an airline database, a Crime Stoppers database, an America's Most Wanted database, and a bail jumper's database.

7. The computer-readable storage medium of claim 1 further comprising instructions that, when executed by the processor, cause the processor to determine, for each attribute, whether the attribute value is in a data format of the data store; and
for each attribute value that is not in the data format of the data store, convert the attribute value to the data format of the data store.

8. The computer-readable storage medium of claim 1 further comprising instructions that, when executed by the processor, cause the processor to determine, for each attribute, whether the attribute value is within an expected range.

9. The computer-readable storage medium of claim 8 further comprising instructions that, when executed by the processor, cause the processor to, in response to determining that an attribute value is not within the expected range, generate an error.

10. The computer-readable storage medium of claim 9, wherein the error includes a reference to the person-of-interest information that caused the error.

11. The computer-readable storage medium of claim 9, wherein the error includes a reference to the data source that caused the error.

12. The computer-readable storage medium of claim 1 further comprising instructions that, when executed by the processor, cause the processor to determine a characterization for each person of interest based on at least one of the attributes characterizing the person.

13. The computer-readable storage medium of claim 12, wherein the characterization is a relative level of danger for each person of interest.

14. The computer-readable storage medium of claim 12, wherein the at least one attribute indicates a crime for which the person of interest has been suspected, charged, or convicted.

15. The computer-readable storage medium of claim 1, wherein the data store is accessible via a network.

16. The computer-readable storage medium of claim 1 further comprising instructions that, when executed by the processor, cause the processor to mark a record as inactive in response to determining that a data source no longer includes information identifying the person associated with the record as a person of interest.

17. The computer-readable storage medium of claim 16, wherein the data source includes a captured list indicating that the person associated with the record is captured.

18 The computer-readable storage medium of claim 16, wherein a specified period of time elapses between the determining that the data source no longer includes information identifying the person as a person of interest and the record being marked as inactive.

19. The computer-readable storage medium of claim 18, wherein the specified period of time is based on the stability of the data source.

20. The computer-readable storage medium of claim 1 further comprising instructions that, when executed by the processor, cause the processor to remove a record from the data store in response to determining that a data source no longer includes information identifying the person associated with the record as a person of interest.

21. The computer-readable storage medium of claim 20, wherein the data source includes an exonerated list indicating that the person associated with the record is exonerated.

22. The computer-readable storage medium of claim 21, wherein a specified period of time elapses between the determining that the data source no longer includes information identifying the person as a person of interest and the removal of the record from the data store.

23. The computer-readable storage medium of claim 22, wherein the specified period of time is based on the trustworthiness of the data source.

24. A computer-implemented method of aggregating person-of-interest information to support an identification system, the method comprising:
extracting person-of-interest information from one or more data sources to a data store, the extracted information being associated with a plurality of persons of interest, each person characterized by a plurality of attributes, each attribute having a respective value;
for each person of interest,
identifying a template corresponding to the extracted information, the template specifying one or more of the plurality of attributes;
parsing the extracted information in accordance with the identified template; and
determining whether the data store includes a record associated with the person,
when the data store includes a record, updating the record; and
when the data store does not include a record, creating a record associated with the person and storing the one or more respective attributes values.

25. The computer-implemented method of claim 24, wherein parsing includes identifying variant forms of attributes values.

26. The computer-implemented method of claim 24 further comprising, converting at least one attribute value from a data format of the data source to a data format of the data store.

27. The computer-implemented method of claim 24 further comprising, verifying for each of the one or more attributes, that the attribute value is within an expected range of values.

28. The computer-implemented method of claim 24, wherein parsing the extracted information further comprises determining a characterization for each person of interest based on at least one attribute value of the parsed information.

29. The computer-implemented method of claim 28, wherein the characterization is a level of threat.

30. The computer-implemented method of claim 28, wherein the at least one attribute value indicates a crime for which the person of interest has been suspected, charged, or convicted.

31. The computer-implemented method of claim 24, wherein the identification system is a scanning device and the scanning device includes a copy of the data store.

32. The computer-implemented method of claim 24, wherein updating the record includes determining whether any of the attribute values are new or changed,
when an attribute value is new or changed, modifying the record to include the new or changed attribute value.

33. The computer-implemented method of claim 24, wherein the extracting is periodically performed by a web crawler.

34. A computer system for aggregating person-of-interest information, the system comprising:
a data store including a plurality of records, each record including a plurality of attributes and being associated with a person of interest, each attribute having a respective value; and
an aggregation service that, for each of a plurality of data sources including person-of-interest information,
retrieves at least a portion of person-of-interest information from the data source, the portion of information being associated with a person of interest;
parses the retrieved information into a plurality of attributes characterizing the person, each attribute having a respective value; and
stores the parsed information in a record associated with the person, wherein the record is included in the data store.

35. The computer system of claim 34, wherein the aggregation service includes a web crawler.

36. The computer system of claim 34, wherein the plurality of data sources are governmental data sources.

37. The computer system of claim 34, wherein the plurality of data sources are non-governmental data sources.

38. The computer system of claim 34, wherein the aggregation service retrieves the portion of information in response to a request received from a user, and wherein the request identifies the data sources from which to retrieve the respective portions of information.

39. The computer system of claim 34, wherein the retrieved portion of data is in a format selected from the group consisting of: a tagged document, a table, a CSV file, and a text document.

40. The computer system of claim 34, wherein at least a portion of the retrieved information is in an unknown data format.

41. The computer system of claim 34, wherein parsing includes identifying variant forms of attributes values.

42. The computer system of claim 34, wherein the aggregation service further determines a relative level of danger based on the attribute values of the parsed information.

43. The computer system of claim 42, wherein at least one of the attributes values indicates a crime for which the person of interest has been suspected, charged, or convicted.

44. The computer system of claim 34, wherein the plurality of attributes are selected from a group consisting of: at least one name attribute, height, weight, age, date of birth, eye color, hair color, and ethnicity.

45. The computer system of claim 34, wherein the plurality of attributes include at least one asset attribute for identifying an asset of a person of interest.
